(19) United States
(12) Patent Application Publication
(10) Pub. No.: US 2011/0066691 A1
(43) Pub. Date: Mar. 17, 2011

(54) INFORMATION SHARING METHOD

(76) Inventor: Nnamdi Jideani, Washington, DC (US)

(21) Appl. No.: 12/882,247

(22) Filed: Sep. 15, 2010

Related U.S. Application Data
(60) Provisional application No. 61/272,348, filed on Sep. 15, 2009.

(51) Int. Cl. G06F 15/16

(52) U.S. Cl. 709/206

(57) ABSTRACT

An information sharing method for placing a communications device in connection with other communications devices located within a predetermined distance. This information sharing method allows users to instantly connect remotely, without face-to-face contact, and to instantly exchange and store contact information to each other's communications devices without manually inputting it. This interaction is facilitated via a conventional network plan coupled with a conventional software application programmed within the communications devices that serve as the hardware element of the present invention. The preferred embodiment for the communications devices relates to communications devices such as mobile phones, although a computing device or laptop configured to send and receive signals and data also may be used.

### CONTINUITY DATA

This is a non-provisional patent application claiming priority to U.S. provisional patent application No. 61/272,348, filed on Sep. 15, 2009.

### FIELD OF THE PRESENT INVENTION

The present invention is a system for placing a communications device in connection with other communications devices located within a predetermined distance. This information sharing method allows users to instantly connect remotely, without face-to-face contact, and to instantly exchange and store contact information to each other's communications devices without manually inputting it. This interaction is facilitated via a conventional network plan coupled with a conventional software application programmed within the communications devices that serve as the hardware element of the present invention. The preferred embodiment for the communications devices relates to communications devices such as mobile phones, although a computing device or laptop configured to send and receive signals and data also may be used.

### BACKGROUND OF THE PRESENT INVENTION

Various methods to perpetuate social networking have exploded over recent years. Websites such as Facebook™ and MySpace™ provide a means for users to search for other people and request or accept a virtual connection. Such connections include the ability to view profiles, images and send messages. Additional methods such as Twitter™ also are available for communicating and sharing profile information. As society became increasingly mobile, all of these methods adapted so that users could connect with others via their mobile phones. However, these methods fail to establish a more immediate connection because current methods require a search of existing members who employ the respective method. A friend-type request can be made, which the recipient could accept, but the person on the other side of the computer may very well not be who he or she claims to be.

The present invention solves this problem by allowing a user to contact other users located within a predetermined distance. This interaction is facilitated via an information sharing method comprising a conventional network plan coupled with a conventional software application programmed within a communications device such as a mobile phone. Unlike existing methods, the system of the present invention is such that a user can transmit a digital image of himself or herself, along with contact information, to others who are operating the present invention within the predetermined distance. The transmission of this initial contact is such that any receiving users will not be known to the first user. In this manner, the receiving user can view the image of the first user and decide whether or not he or she wishes to accept this invitation and ultimately share his or her information in return.

An example scenario relates to a nightclub. Current information sharing methods do not afford a person the ability to pick and choose other people to meet up with via electronic or digital means. This means that for the most part, a person must perform the old fashioned method of walking up to someone and taking the time to learn basic details. This obviously has caused embarrassment and nervousness for people for as long as the dating scene has existed. Current social networking methods do not help because they tend not to be based on immediacy, and the best a current social networking method can do is establish a line of communication among people to ultimately agree to meet up at a specific location. As such, there remains a need for a system that empowers a person with the ability to electronically connect via an initial profile with others already located within the same area. In this manner, the receiving users can view the profile to determine whether or not they are interested in pursuing the connection. If some of these unknown users reject the invitation, then it saves the first user a lot of time and pride in dating situations. It is, however, important to note that the present invention uses the same concept to relate to other scenarios such as business and professional networking None of the existing social networking methods solve this need, meaning that the present invention is truly novel.

Because it is desirable to provide a proximity networking tool that is not merely an electronic business card, a visual-based information sharing method requiring a photo (i.e., a digital image) should be provided. Such a method's primary use might be geared towards, but not limited to, social networking users, who would find it easier to meet, greet and socialize. Moreover, a successful visual oriented method should eliminate the need for a user to manually input information for each new contact. After a primary set-up stage, which should include profile customization and photo upload, users should be able to experience the convenience and effortless sharing of information when in proximity to each other.

While there are a plethora of social applications capable of running on users' mobile communications devices, the present invention allows users to instantly connect and exchange profiles that include digital photos of themselves, with the connection being based on proximity of the users to each other, and the profiles selectively being entered into the users' mobile address books. If such an application existed, it would function as an ‘ice-breaker’ application having the capability of bringing people together with complementary business interests, social interests, and the like.

Technologies such as the Lovegety™ and Bluetooth™ (the latter used for “Bluedating”) fail to solve these problems because they do not permit the requisite visuals and decision-making elements of the method of the present invention. Those items also rely on radio frequency communications that, combined with other aspects of such devices, do not provide the capability for a user to receive or send an invitation, or to decide and ultimately act upon a decision to accept and share further pre-programmed information from the other users.

U.S. Pat. No. 6,664,891, issued to Davies et al. on Dec. 16, 2003 is a software/firmware application, embodying a service similar to the information sharing method, utilizing existing telecommunications protocols running on mobile communications devices. Davies et al. is configured for a user to send inquiry messages to at least one receiver, unlike the present invention, which sends user profiles to all receivers within a predetermined distance.

U.S. Pat. No. 7,418,268 issued to Cabano et al. on Aug. 26, 2008 is a method that allows users of terminals to find members of a common interest group. Cabano et al., in sending signals, discriminates on the basis of membership in an interest group, whereas the present invention allows all persons employing the application within a predetermined distance to receive a sent signal.

U.S. Patent Application Publication 2008/0051033 issued to Hymes on Feb. 28, 2008 is for initiating contact via a telecommunications system with a specific person within the user's vicinity, employing the specific person's distinguishing characteristics to determine a telecommunications address through which initial contact can be made. Hymes differs from the present invention, in that the present invention is designed to send a profile of the sender to all persons also using the present invention within a predetermined distance.

U.S. Patent Application Publication 2009/0003662 issued to Joseph et al. on Jan. 1, 2009 is for a mobile social networking system designed to provide social information about nearby people in an unobtrusive and inconspicuous manner. Joseph et al. differs from the present invention, in that Joseph et al. uses augmented reality systems, whereas the present invention does not.

### SUMMARY OF THE PRESENT INVENTION

The present invention is an information sharing primarily for use on cell phones or other mobile communications devices. The present invention allows a “chime” invitation to be sent between persons within 100 feet of each other when they have the present invention operational on their communications devices. The first person, or “chimer,” hits the chime button to send an invitation. On the recipient's communications device, a pop-up with profile information and a thumbnail picture of the chimer appears, and the chime invitation is placed in the recipient's profiles received storage area. If the recipient accepts the chime invitation, the chimer's profile is automatically added to the recipient's profiles storage area. If the recipient declines the invitation, then the chimer's profile information is not added into the recipient's profiles storage area. If the recipient chooses the “text only” feature, then users can exchange text messages without the recipient sharing his or her contact information. If the recipient suspends the chime invitation, it will be stored in the recipient's suspended profiles storage area for later review. If the recipient so chooses, the recipient may send his or her profile information to the sender as well.

The present invention also provides a means by which users can leave the information sharing method switched “OFF”, both to conserve battery power and to automatically decline any unwanted invitations from other users. The method also provides a “Standby” mode (for bar/lounge or social gathering) in which open invitations are captured by the recipient's communications device. The standby mode is an automatic switch in that the present invention goes to standby only when it is awaiting a signal.

Uses of the present invention are numerous. For example, a user of the information sharing method named Tyrus concludes his presentation at a board meeting. He states that anyone who has questions should contact him on his cell phone. To acquire Tyrus' contact information, all 15 board members switch their information sharing application to the “On/Standby” mode. Tyrus then utilizes the chime button to send his invitation from his mobile to the mobile phones of all board members. The invitation appears like a pop-up text message on the mobile devices of the members. On each of these mobile devices, the pop-up shows a picture thumbnail of Tyrus, his name, title, work number, cell number and e-mail address in the contact information area. After all 15 members push the “Accept” buttons on their devices, a signal is sent to Tyrus' device confirming all parties and recognizing them by their digital images. Once each party is confirmed, another signal is sent to all parties stating that the contact (Tyrus) was stored in their contacts list. A message then pops up asking the board members if they would like to share their information in return. For each board member who answers yes, a signal is sent to Tyrus, and for those he confirms, their contact information will be stored in his mobile device.

In another example of the present invention, user A and user B are in close proximity (within 100 feet). User B can either press the chime button to send a chime invitation or press a “Menu” button to open up a chime menu. A chime menu may be comprised of a plurality of tabs, including personal, business and custom tabs. Also provided are a “Chime Log Tab-Sent”, which displays invitations sent; “Chime Log Tab-Received”, which displays invitations received; and “Chime Log Tab-Suspended”, which displays invitations postponed for later review and stored in a chime database. Suspended users can still be added later to the user's mobile communications device, or declined.

In another example, user A wants to send a chime invitation to user B, but doesn't want to share his/her personal information. User A would still like his or her default profile to be the personal profile, yet user A only wants to share his or her business profile this one time. To do this, instead of pressing the chime button to send an invitation, user A presses on the menu button, and a chime menu appears. User A then selects the profiles tab, from which user A's business profile can be selected. The business profile then illuminates and user A presses the “Save” button, but does not select the “Set As Default” button, and presses the chime button to send the invitation. User A's business profile would then be received by user B. Also available is a custom profile that can include business and personal information along with anything extra, such as Twitter and Facebook ID's, hobbies, and the like.

The present invention also enables users to receive multiple chimes and send group chimes. For example, if user B receives chime invitations from users A, C, D, E, F and G, the present invention triggers a chime invitation sound to alert user B of the incoming invitations. The information sharing software method displays invitations grouped with the earliest invitation in front. User B then presses on the navigation arrow to scroll through the invitations. If user B selects user F and presses on user F's photo digital image, the present invention then maximizes user F's invitation. As described above, user B then has the option to accept, decline, suspend or “text only” user F's invitation.

In addition, universities and other institutions could use the present invention for training and teaching purposes. It should be understood that the information sharing method can also be implemented on laptops, desktops and other computing devices, in addition to the aforementioned mobile communications devices.

While Bluetooth™ is contemplated as the transport mechanism for the information sharing method, other wireless transport mechanisms are also contemplated. Notwithstanding the fact that Bluetooth™ ranges are listed as 100 meters, the method's preferable requirement of approximately 300 meters may still be achieved using well-known technology such as a Bluetooth™ with a high gain Bluetooth™ dongle.

These and other features of the present invention will become readily apparent upon further review of the following specification and drawings.

### BRIEF DESCRIPTION OF THE DRAWINGS

FIG. 1 shows an example communications device employing the present invention.

FIG. 2 is a front view of a collection of profiles that can be edited and customized using the present invention.

FIG. 3 shows an example thumbnail gallery on a communications device employing the present invention.

FIG. 4 shows an example ON/OFF slide switch display screen on a communications device employing the present invention, the switch being in the “ON/Stand By” position.

FIG. 5 shows an example ON/OFF slide switch display screen on a communications device employing the present invention, the switch being in the “OFF” position.

FIG. 6 shows an example menu screen on a communications device employing the present invention.

FIG. 7 shows an example contact-added screen on a communications device employing the present invention.

FIG. 8 shows an example multiple chimes screen on a communications device employing the present invention.

FIG. 9a is the first part of a flow chart detailing the processes of the present invention.

FIG. 9b is the second part of a flow chart detailing the processes of the present invention.

FIG. 9c is the third part of a flow chart detailing the processes of the present invention.

### DETAILED DESCRIPTION OF THE PREFERRED EMBODIMENT

The present invention is an information sharing method primarily for use on a communications device (5). Communications device is used in this description to denote any personal digital device capable of utilizing the present invention, such as a cell phone, Personal Digital Assistant (PDA), or similar mobile device, as well as a laptop, desktop or other computing device.

The present invention operates in this fashion: a user with the present invention loaded on a first communications device (30) can send a invitation in the form of a profile (40) to an at least one additional communications device (35) employed by one or more users of the present invention, if all the users are within a predetermined distance (envisioned in the preferred embodiment as between 100 to 300 feet). The users are linked to one another via a conventional network plan. The profile (40) serves as a “chime invitation” to other users with in-range, similarly equipped communications devices (5), and sending the profile (40) is called “chiming.” The person doing the chiming is called a “chimer.” To send a profile (40), all a chimer need do is hit the chime button (305). If the profile (40) is accepted by the at least one user of the at least one additional communications device (35), a confirmation message (50) and a return profile (55) will be sent from the at least one additional communications device (35) to the first communications device (30). The at least one additional user will also have other options as well, as illustrated in the figures below.

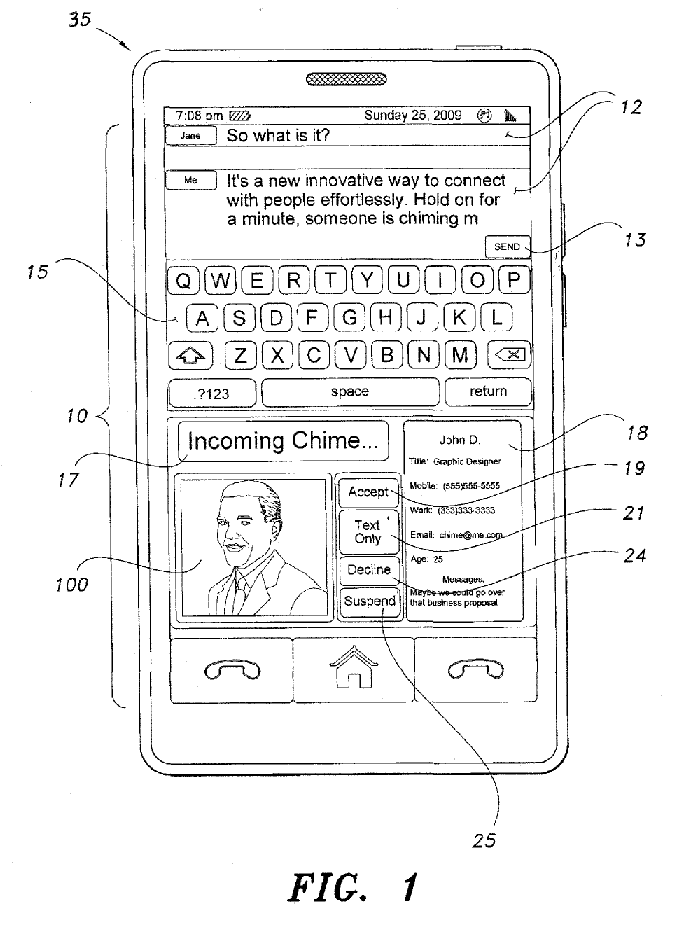

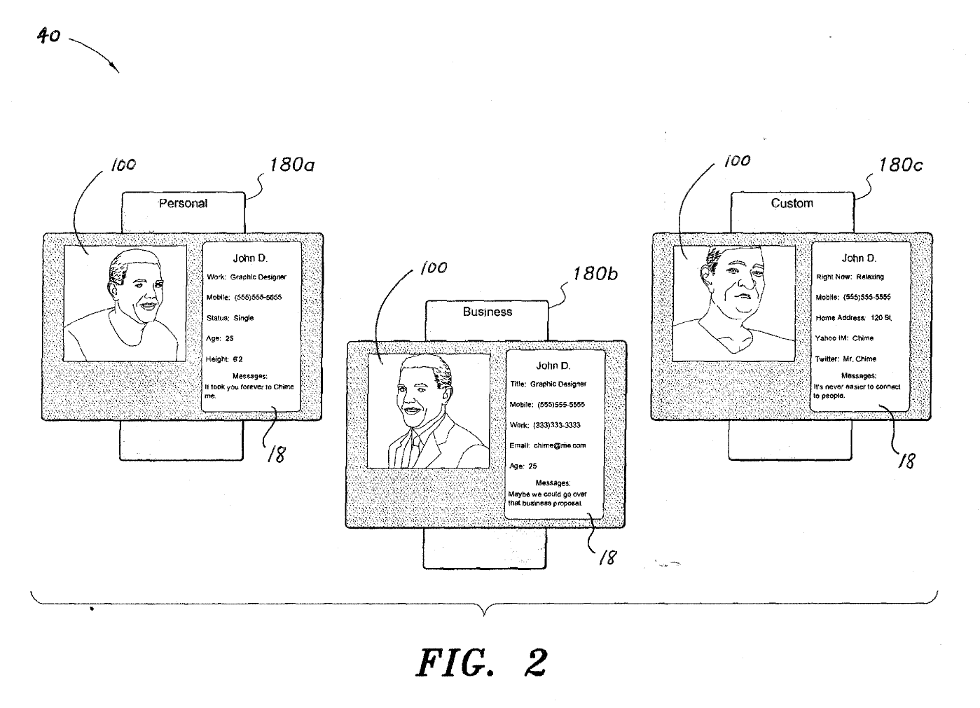

As shown in FIG. 1, when a user receives a chime invitation, the user is alerted by the Incoming Chime display (17), and a pop-up screen (10) with a digital image (100) of the chimer appears on the user's communications device (35). An Accept button (19), a Text Only button (21), a Decline button (24), and a Suspend button (25) appear on the pop-up screen (10) along with contact information (18) of the chimer. If the recipient presses the Accept button (19), the invitation is accepted and the chimer's profile (40) (see FIG. 2), which consists of the chimer's digital image (100) and contact information (18), is automatically added to the address book of the recipient's communications device (35).

A chime invitation can be returned by the recipient, causing his or her contact information to be similarly shared with the chimer. On the other hand, if the recipient presses the Decline button (24), the initial invitation is blocked and the chimer's contact information is not accepted into the recipient's phone. Another option provided by the information sharing method is the “text only mode,” for which the recipient pushes the Text Only button (21). Pressing the Text Only button (21) enables users to exchange text messages in text fields (12), writing them by using the keyboard (15) and sending them by pressing the Send button (13), without any contact information being shared.

As shown in FIG. 2, a personal profile (180a), business profile (180b), and custom profile (180c) may be created. Each user must create at least one profile (40) to represent himself or herself as a user of the information sharing method, but the method assures that recipients will only see what the sender (i.e., chimer) wants to reveal. This is accomplished by providing the user a plurality of profiles (40) that can be created by the user to be used in different circumstances. The custom profile (180c) can include a correlation of business profile (180b) and personal profile (180a) information along with any extra information such as Twitter and Facebook ID's, hobbies, favorite color, favorite food, and the like. On each of these profiles (40) is a digital image (100) and contact information area (18), with name, title, work phone number, cell phone number, and email address. Chime profiles (40) can be updated via a USB connection between a user's phone and personal computer. The present invention provides a means for editing each profile, either through the user's communications device (5) (see FIG. 1) or a wide area network server. If editing through the server, a user logs into his or her account, uploads a representative digital image (100), and edits information he or she would like to share when sending a profile (40). If editing in a standalone mode on the communications device (5) (see FIG. 1), a user merely uploads the representative digital image (100) locally from a laptop, desktop, memory card, or the like, and then edits the shared information.

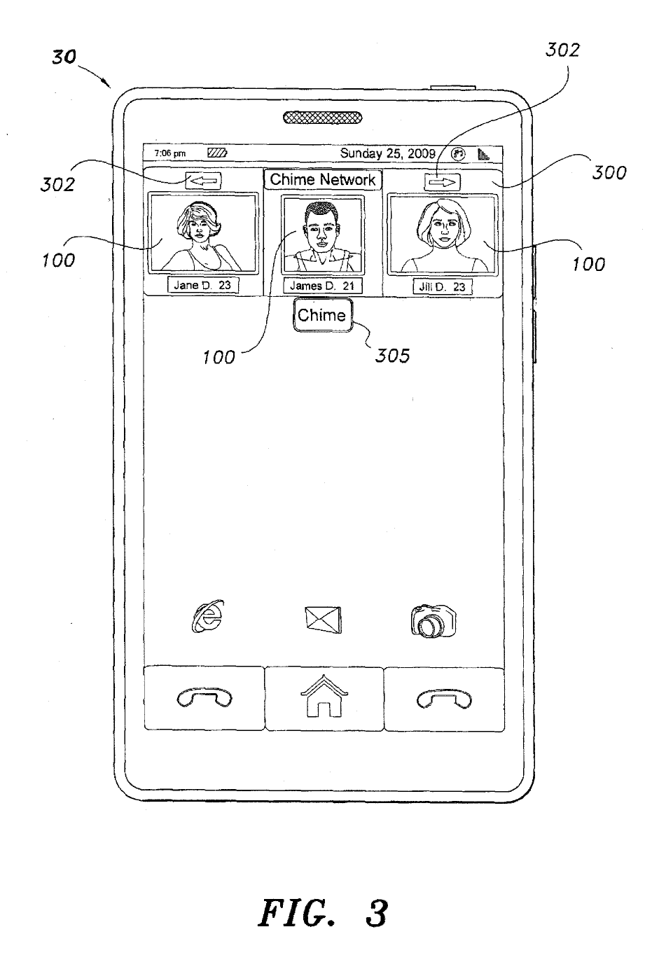

As shown in FIG. 3, the information sharing method enables users to receive multiple chimes and send group chimes. For example, if a user receives chime invitations from “Jane D.”, “James D.”, and “Jill D.” (as shown in FIG. 3), the present invention triggers a chime invitation sound to alert the user of the incoming invitations and the invitations will be stored in the user's chime network (300). In FIG. 3, the present invention displays invitations on the first communications device (30) grouped with the earliest invitation in front. The user then presses on the navigation arrow (302) to scroll through the invitations. The user presses on the digital image (100), and the software then maximizes the invitation. As described above, the user can accept, decline, or suspend the invitation, or respond with a text message to the invitation. To send multiple invites, the user hits the Chime button (305). If the chime network (300) displays seven users within the predetermined distance of the present invention, then by scrolling and selecting the representative digital images (100), the user can select a subset of the users shown in the network (300), e.g., just six contacts. After each contact is highlighted, the user presses the Chime button (305). A confirmation message (50) (not shown in FIG. 3) then displays, asking the user if chime invitations should be sent to all selected contacts, to which the user answers in the affirmative.

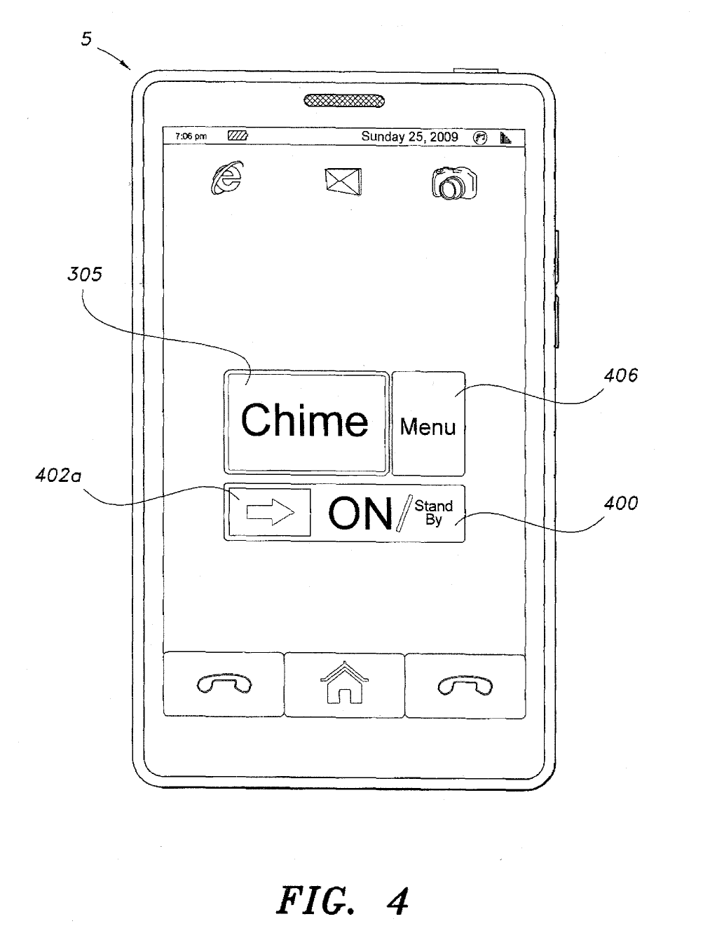

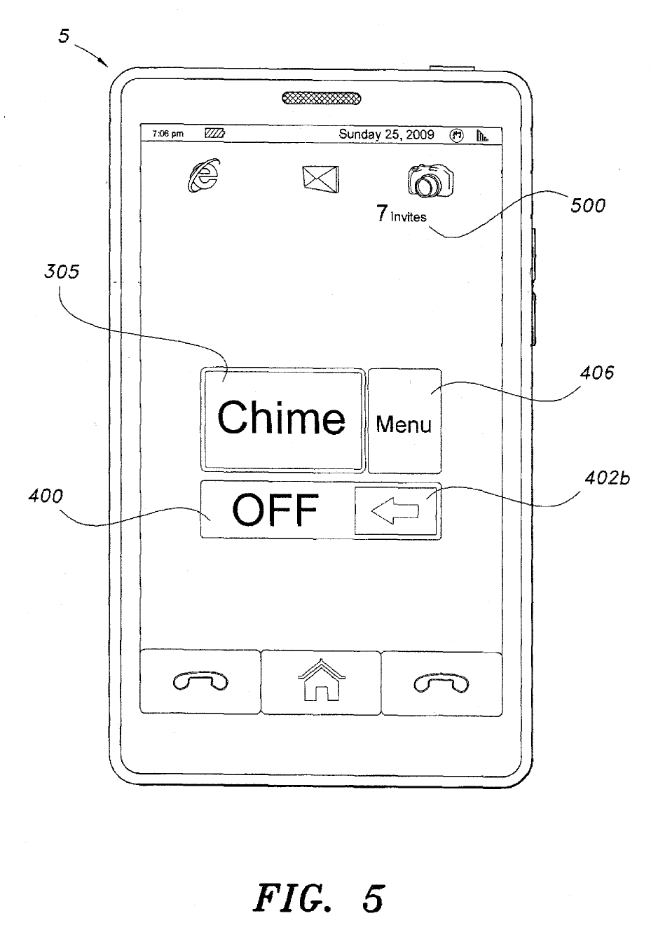

An example “OFF/ON” virtual slide switch (400) is shown in FIG. 4 and FIG. 5. FIG. 4 shows the present invention in “OFF” mode, with the right pointing arrow (402a) pointing at the “ON/Standby” selection on the slide switch (400). The Chime button (305), Menu button (406) are also shown on the communications device (5). FIG. 5 shows the method in “ON” mode, in which chime invitations can be captured. When the “ON” mode is selected, the left pointing arrow (402b) points at the “OFF” selection on the slide switch (400). FIG. 5 also shows the total invites notification (500) that is displayed when the software is in the “ON” mode. The Chime button (305) and Menu button (406) illuminate in the “ON” mode, showing that the Chime application is on and active when connection has been established.

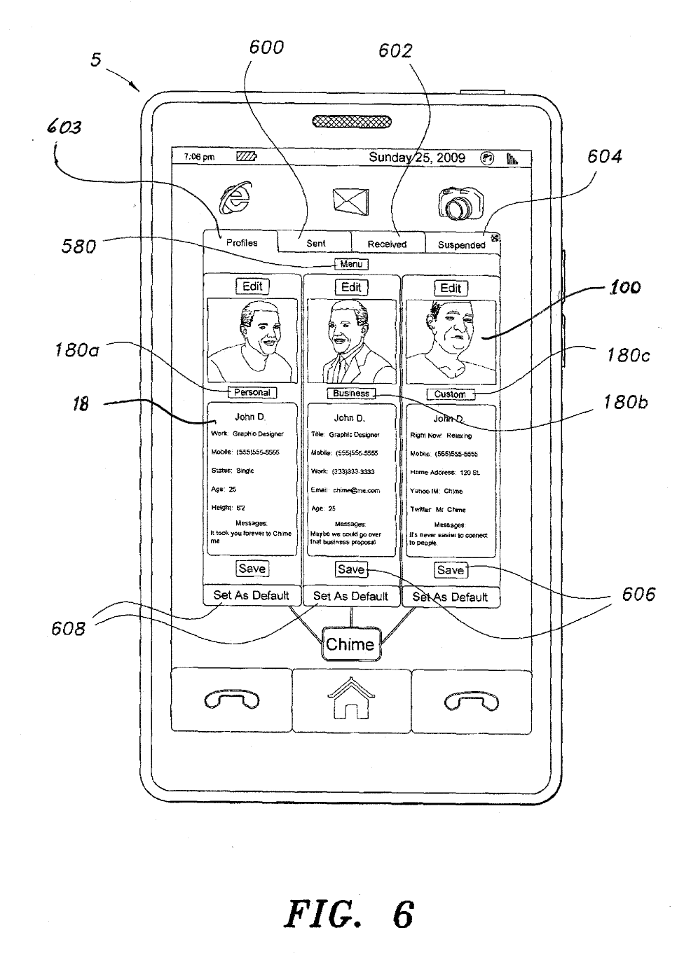

FIG. 6 displays a communications device (5) showing the present invention's home menu screen (580). From the home menu screen (580), the user can edit any of his or her profiles (40) (see FIG. 2). The user selects either the personal profile (180a), business profile (180b), or custom profile (180c), causing it to illuminate and allow the user to change the contact information (18). The user can also upload a representative digital image (100) by locating it on the communications device (5) or connecting to another device or storage card to obtain the digital image (100). A Save button (606) is provided which saves the digital image (100) and contact information (18). Additionally, each of the three profile types (180a and 180b and 180c) has a “Set As Default” button (608) that sets that particular type as the default that will be sent to users of the information sharing method within the predetermined distance.

Continuing with FIG. 6, a chime menu (580) is shown with its plurality of tabs. These tabs include the Chime Log Tab-Profiles (603), opened in FIG. 6 to show the user's personal profile (180a), business profile (180b), and custom profile (180c). Other tabs shown are the Chime Log Tab-Sent (600), which displays invitations sent; the Chime Log Tab-Received (602), which displays invitations received; and the Chime Log Tab-Suspended (604) which displays invitations postponed for later review and stored in a chime database. Suspended users can still be added to the phonebook of the user's communications device (5), or declined.

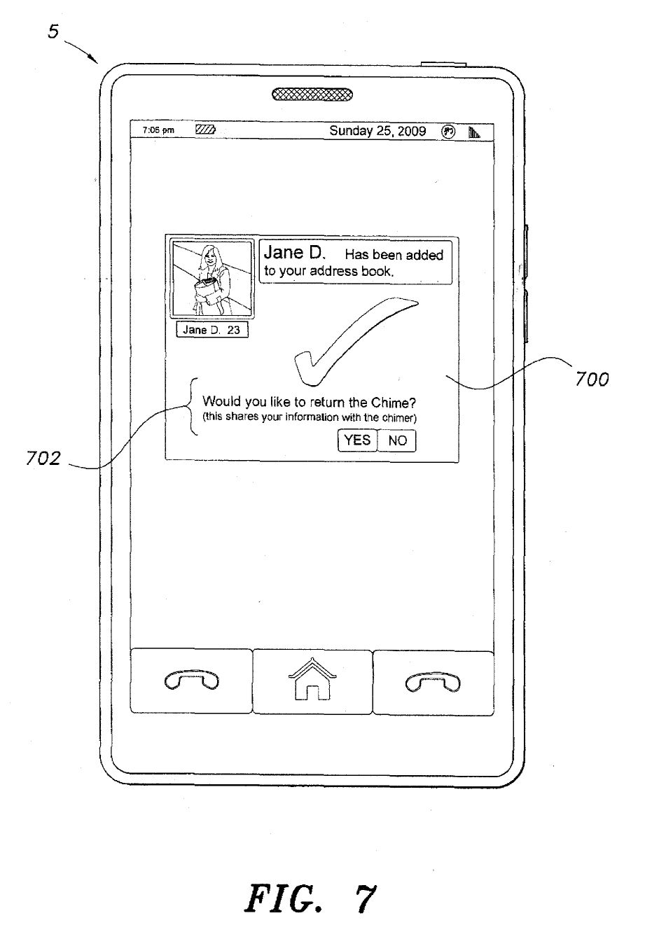

FIG. 7 shows a communications device (5) displaying the Contact Added screen (700). The Contact Added screen (700) makes a recipient aware that a specific contact has been added to the address book, and provides a Yes/No prompt (702) that asks the recipient whether he or she wants to return the chime invitation by sharing information with the chimer.

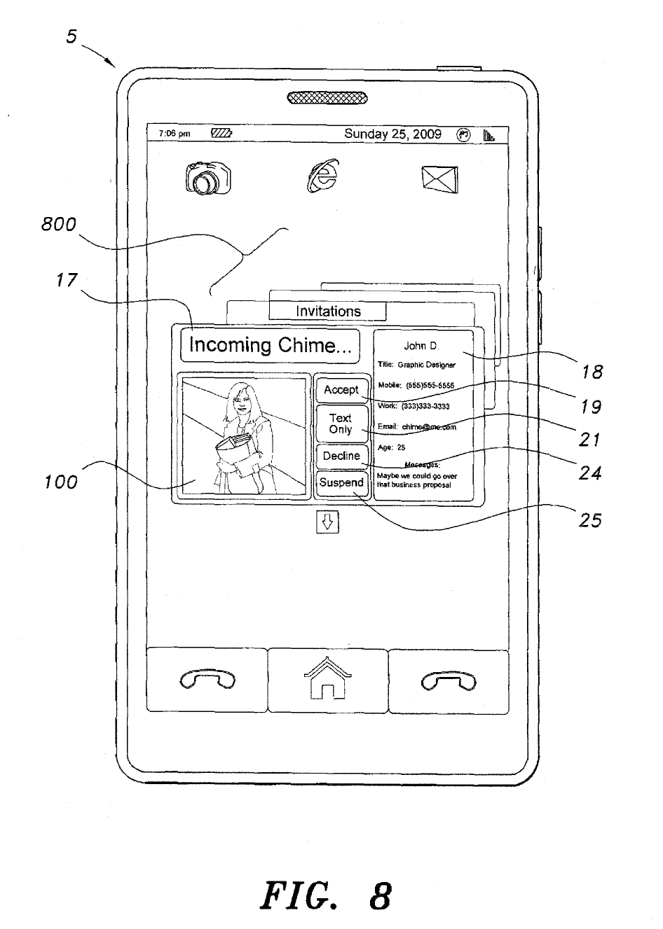

FIG. 8 demonstrates the present invention's capacity to handle multiple chimes sent to a communications device (5). The present invention provides a virtual stack (800) of chime invitations. Each invitation shows the sender's representative digital image (100) and contact information (18). The recipient user can select which of the invitations in the virtual stack (800) the user wishes to process. Each invitation in the virtual stack (800) has an Incoming Chime display (17) and an Accept button (19), Text Only button (21), Decline button (24), and Suspend button (25).

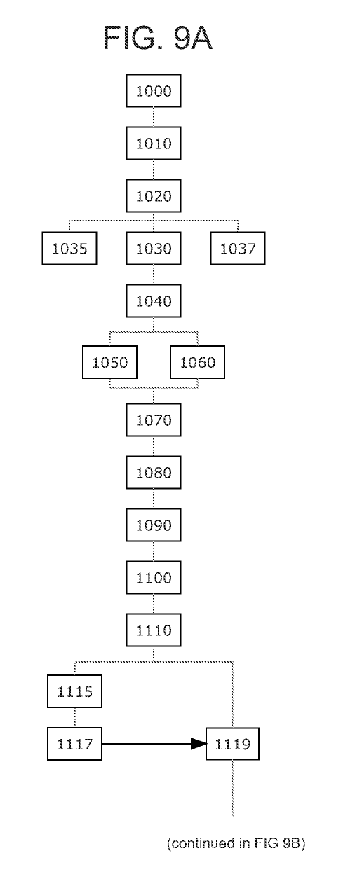

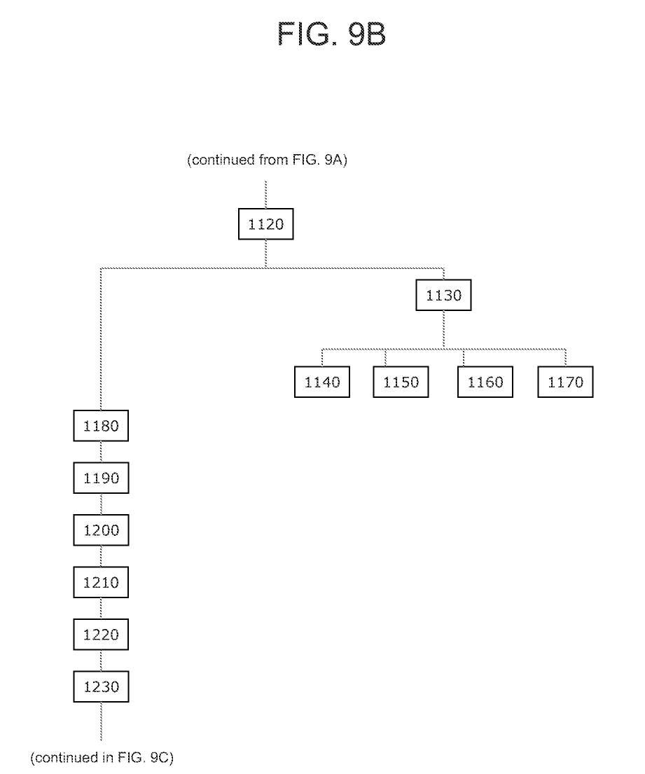

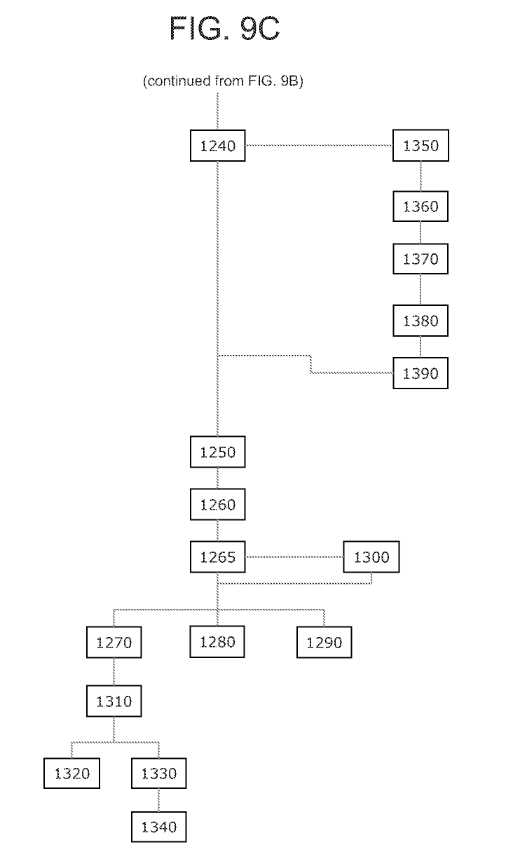

FIG. 9a, FIG. 9b, and FIG. 9c make up a flow chart showing the processes of the preferred embodiment of the present invention. Looking at FIG. 9a, the first step is for a user to activate a communications device (1000). The communications device in the preferred embodiment is a mobile phone or similar communications device configured to operate a conventional software application. The communications device is typically linked to a network plan (1010) to permit the transmission and receipt of data and signals. The communications device will conventionally communicate with a server or data storage area to ultimately download the software application of the present invention (1020).

Once the software application of the present invention is placed within the communications device, the user can create separate profiles. In the preferred embodiment of the present invention, the user will have the ability to create a personal profile (1030), business/professional profile (1035) and a custom profile (1037). The profiles are meant to represent the user in the context of appropriate situations. While this step in the process is more for the user to create the profiles, the user will ultimately reach a point of editing and populating each profile with relevant information. For example, a personal profile may include such information as marital status, age and a more casual photo. The business/professional profile would be a bit more formal in the information conveyed. The custom profile would be anything else the user would consider conveying. This could include such items as various contact details and activity status.

Once the profiles are created, the user will click on a menu tab or button (1040). This will permit the user to edit and enter additional information (1050) into the profiles. The user also will have the ability via conventional means to upload an image (1060) into all profiles. In this manner, the image may be different for each separate profile. For example, a casual photograph of the user may be uploaded into the personal profile while a photograph of the user in business attire may be uploaded into the business/professional profile. After images are uploaded and profiles are edited or populated with information, the user can save this information into the present invention (1070). The user also will have the option to save a specifically designated profile as the default (1080). In this manner, the default will be the primary profile to appear when the present invention is in use. The user in the preferred embodiment can operate a button or tab on the communications device to set which profile will be the default.

By clicking on an icon, tab or button of the present invention when the communications device is receiving power via conventional means, the software application will activate (1090). This activation is such that the present invention can be used to transmit and receive data and information. However, in the preferred embodiment, the ability to transmit and receive data and information via the software application does not need to be activated in order for the user to edit profiles or view a log of past data and information transmissions and receipts.

Once the present invention is activated, the display screen of the communications device will display such items as the menu, network service information, and other items for use (1100). Once activated, the present invention also will search for network service (1110) via conventional means relating to the interaction between the communications device and the software application. If no service is located (1115), then the present invention in the preferred embodiment will go into a standby mode (1117) where the software application is effectively waiting until service is established. Once the network service is established (1119), the present invention will indicate that the connection is established.

Looking now at FIG. 9b, the present invention is capable via the communications device and software application of communicating data and information with other users located within the predetermined distance who also have an activated software application via a communications device (1120). At this point, the user can either press an icon, tab or button on the present invention to transmit data and information to others within predetermined distance (1180) or press a menu icon, tab or button to view information contained in the menu database contained within the software application (1130). In the preferred embodiment of the present invention, the menu will include at least four tabs. These tabs contain a profile tab (1140) that relates to further data within the various individual profiles saved in the software application. A sent tab (1150) displays, records and logs invitations, data, and information that have been transmitted by the user to others also using the present invention. A received tab (1160) displays, records and logs invitations, data, and information that have been received by the user from others also using the present invention. A suspended tab (1170) displays, logs and records invitations, data and information that have been postponed or otherwise not taken action upon. The suspension tab (1170) allows the user to review such information, data, or invitations at a later date or time, while also permitting the user to add such information to their general contact data within the software application or communications device.

When the user acts to transmit data and information to others within the predetermined distance (1180), the present invention will scan the area for other users engaged in the present invention within the confines of the predetermined distance (1190). The preferred embodiment of the predetermined distance is 100 feet from the communications device. However, additional embodiments relate to modified distances. Still further embodiments relate to permitting a user via conventional means to switch among a variety of distance ranges to accommodate the individual circumstances, location and desired usage of the present invention at that time.

At this point, the present invention will locate all other users who have also activated the present invention in the manner described above and within the predetermined distance (1200). These users, via either their set profiles or images alone, will be displayed on the display screen of the communications device of the user of the present invention (1210). The user may then select the photo or image of any of the additional users (1220) when the data and information of these additional users are received by the present invention in the manner described above. Once an additional user is selected by the user, a confirmation request will appear on the display screen of the communications device (1230) to ensure that the user indeed wants to exchange profile and communications data and information with that particular additional user.

Looking now at FIG. 9c, when the user confirms, the present invention via the network, software application and communications device, will initiate a connection between the user and the additional user (1240). An invitation, or request to further exchange profile and other information and data, will then be transmitted from the user to the additional user (1250). The additional user, also referred to as the receiving user, will have his or her software application and communications device operational just like that of the user (1260), the user also referred to as the first user. When the receiving user receives a notification of an incoming invitation, the receiving user's display screen will display the image and profile information of the user (1265). The receiving user then has the options contained in the preferred embodiment to accept the invitation of the user (1270); decline the invitation of the user (1280), limit interaction to text messages through the software application such that the receiving user's information is not shared (1290), or suspend the invitation and place it in storage in the memory of the present invention for later review (1300).

When the receiving user elects to accept the invitation of the first user, the information and data of the first user, to include the image and contact information, is stored within the software application of the receiving user's connection device of the present invention (1310). In the preferred embodiment, this will place the data and information of the first user into a phonebook, address book or other memory storage outlet of the receiving user's software application and mobile phone or other communications device memory. A confirmation notice will be displayed on the display screen.

From there, the receiving user will have the option to reciprocate by approving the transmission of the receiving user's data and information, to include contact information, to the first user (1320). The receiving user also may elect to not approve of such a transmission of contact information (1330). But when approval is granted, both the first user and the receiving user will have each other's contact information, data and information stored within the communications device of the present invention via the software application (1340).

In instances where the first user wants to connect with a third user or additional users, the first user may elect to target the third user with an additional profile via using the menu to set a different profile. For example, the first user may have established a connection via the default personal profile with a second user, but may want to initiate a more professional demeanor with the third user. This is conducted in the preferred embodiment by accessing the menu of the present invention (1350) and clicking on the profile tab (1360). The first user will select a profile that is different from the default (1370) while maintaining the same actual default. In this embodiment, the first user will save the different profile (1380), the different profile again not being saved as the default but rather merely a current profile for that targeted use. At this point, the different profile will be used while maintaining the initial default profile (1390).

In summary, the present invention is an information sharing method, comprising linking a first communications device (30) and an least one additional communications device (35) to a network plan; creating at least one profile (40) on the first communications device (30), the at least one profile (40) containing a digital image (100); scanning an area within a predetermined distance of the first communications device (30) for the at least one additional communications device (35); and transmitting at least one profile (40) from the first communications device (30) to the at least one additional communications device (35), when the first communications device (30) and the at least one additional communications device (35) are within the predetermined distance.

Furthermore, the present invention also comprises popping up the at least one profile (40) like a pop-up text message on the at least one additional communications device (35); accepting the at least one profile (40) from the first communications device (30) on the at least one additional communications device (35); rejecting the at least one profile (40) from the first communications device (30) on the at least one additional communications device (35); suspending the at least one profile (40) from the first communications device (30) on the at least one additional communications device (35); selecting a text only messaging option for communicating with the first communications device (30) on the at least one additional communications device (35).

Additionally, the present invention comprises storing the at least one profile (40) in the at least one additional communications device (35); transmitting a confirmation message (50) from the at least one additional communications device (35) to the first communications device (30); sending a return profile (55) from the at least one additional communications device (35) to the first communications device (30); placing the at least one profile (40) from the first communications device (30) in a received log (602) in the at least one additional communications device (35); storing the at least one profile (40) from the first communications device (30) in a suspended log (604) in the at least one additional communications device (35) for later review; and maintaining anonymity for a user of the at least one additional communications device (35).

Finally, the present invention is a communication system, comprising broadcasting an at least one profile (40) from a first communications device (30) to an at least one additional communications device (35) only when the at least one additional communications device (35) is within a predetermined distance from the first communications device (30); sending, but not broadcasting, an at least one profile (40) from the at least one additional communications device (35) to the first communications device (30); and wherein said broadcasting is not user specific.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

1. An information sharing method, comprising:
linking a first communications device and an least one additional communications device to a network plan;
creating at least one profile on the first communications device, the at least one profile containing a digital image;
scanning an area within a predetermined distance of the first communications device for the at least one additional communications device; and
transmitting the at least one profile from the first communications device to the at least one additional communications device, when the first communications device and the at least one additional communications device are within the predetermined distance.

2. The method of claim 1, further comprising popping up the at least one profile like a pop-up text message on the at least one additional communications device.

3. The method of claim 1, further comprising accepting the at least one profile from the first communications device on the at least one additional communications device.

4. The method of claim 1, further comprising rejecting the at least one profile from the first communications device on the at least one additional communications device.

5. The method of claim 1, further comprising suspending the at least one profile from the first communications device on the at least one additional communications device.

6. The method of claim 1, further comprising selecting a text only messaging option for communicating with the first communications device on the at least one additional communications device.

7. The method of claim 3, further comprising storing the at least one profile in the at least one additional communications device.

8. The method of claim 3, further comprising transmitting a confirmation message from the at least one additional communications device to the first communications device.

9. The method of claim 3, further comprising sending a return profile from the at least one additional communications device to the first communications device.

10. The method of claim 4, further comprising placing the at least one profile from the first communications device in a received log in the at least one additional communications device.

11. The method of claim 5, further comprising storing the at least one profile from the first communications device in a suspended log in the at least one additional communications device for later review.

12. The method of claim 1, further comprising maintaining anonymity for a user of the at least one additional communications device.

13. A communication system, comprising:
broadcasting an at least one profile from a first communications device to an at least one additional communications device only when the at least one additional communications device is within a predetermined distance from the first communications device;
sending, but not broadcasting, an at least one profile from the at least one additional communications device to the first communications device; and
wherein said broadcasting is not user specific.
